(19) United States
(12) Patent Application Publication
(10) Pub. No.: US 2005/0135107 A1
(43) Pub. Date: Jun. 23, 2005

(54) L.E.D. lamp ring

(76) Inventors: Robert M. Currie, Dollard-Des-Ormeaux (CA); Eliot Sorella, Laval (CA)

Correspondence Address: Merek, Blackmon & Voorhees, LLC, 673 S. Washington St., Alexandria, VA, 22314, US

(21) Appl. No.: 10/901,027

(22) Filed: Jul. 29, 2004

Related U.S. Application Data
(60) Provisional application No. 60/490,441, filed on Jul. 29, 2003.
(60) Provisional application No. 60/490,445, filed on Jul. 29, 2003.

(51) Int. Cl. F21S 2/00

(52) U.S. Cl. 362/382

(57) ABSTRACT

A lamp adapter for mounting a number of LEDs between a lamp and a light bulb. A bulb socket on the adapter threads into the socket of a lamp to power a number of LEDs mounted about the periphery of the lamp socket. A positive and negative electric lead are insulated and arranged to receive LEDs mounted directly onto the leads to power the LEDs. Preferably the LEDs are mounted in a ring around the outer portion of the lamp adapter. A central portion of the lamp adapter is configured to receive a standard light bulb such as a 60 W bulb. When assembled a normal lamp has the lamp adapter or lamp ring mounted between the lamp and the light bulb to provide night lighting or decorative effect to the light without requiring a separate power source.

### CROSS REFERENCE TO RELATED APPLICATIONS

This application claims the benefit of U.S. Provisional Application 60/490,441 filed Jul. 29, 2003, which is hereby incorporated by reference. This application also claims the benefit of U.S. Provisional Application 60/490,445 filed Jul. 29, 2003, which is hereby incorporated by reference.

### BACKGROUND OF THE INVENTION

A. Field of the Invention

The instant invention relates to a light emitting diode in combination with decorative and functional lighting.

B. Description of the Prior Art

At the present time there are numerous light emitting diode (herein after LED) lights available to the public for various purposes. LEDs are used as on/off indicators on almost every electrically powered appliance, in large numbers as red, green, and amber traffic lights, in signs, and in many other applications. However, none of the prior art inventions and patents, taken either singly or in combination, is seen to describe the instant invention as claimed.

### SUMMARY OF THE INVENTION

The present instant invention uses new solid state lighting technology to inventively create a new solid-state combination lamp mood light and night-light. This invention is a one-piece unit that screws into any lamp socket just as an ordinary light bulb screws into the lamp socket. The difference is that the light bulb then screws into the one-piece lamp mood light/night light unit. An electrical switch on the side of the LED light now controls the on/off condition of the light bulb and the on/off of the ring of colored LEDs located around the base of the light bulb. There is preferably different colors of LEDs and the electrical switch preferably has several positions used to energize the different colors singly or in combination. There may be electrical circuits in the mood light to cause the LEDs to illuminate in sequence or in other pre-programmed sequences. In one embodiment, the light may contain a photocell to switch electrical power on to the LEDs when darkness falls thereby creating a night light out of a normal table lamp. The color of the night-light is preferably switch selectable. The light may be a mood light containing an electrical circuit sensitive to sound or motion and set to illuminate the ring of LEDs when either occurs within its' sensing area.

The present invention utilizes eight super bright, solid-state light emitting diodes mounted to shine in a vertical direction, however the mounting direction of the LEDs may vary and be at any angle or combination of angles. One skilled in the art would recognize that the number of LEDs can be increased or decreased for ornamental effects or to change the effective brightness or wattage of the light.

The solid state LEDs preferably each have soldered electrical connections and electrically will last indefinitely, or the LEDs may have miniature socket connections allowing the user to replace the installed LEDs with different colored LEDs. A light transmissive removable cover is colored white, colored a specific color, or combination of colors, or may be frosted to cover the ring of LEDs. This cover would serve to blend the emitted light of the LEDs creating very colorful special effects, especially when the electrical circuits illuminate different colored LEDs in combination. The LEDs are generally mounted equally spaced around in a circle on the metal surface of the heat shield, however the LEDs may be mounted in any location on the mood light and in any direction including down. LEDs mounted to direct light downwardly would illuminate the area proximate the base of the lamp further enhancing both the mood and night light characteristics of the instant invention. An electrical circuit that rectifies 115-VAC house current and reduces the DC output voltage to that required by the electrical series, series parallel, or parallel connection of the multiple LEDs is located in the base of the mood light ring beneath the metal surface upon which the LEDs are mounted.

A removable, optically conductive lens cap or cover is press fitted, or threadedly attached to cover the LEDS of the mood light ring. The acrylic or other plastic cover over the LEDs not only blends and combines the illumination from the different colored LEDs but also disperses and diffuses the light from the LEDs out of the bulb globe in any and all directions When electrical power is applied to the LEDs of the mood light ring, and the lens cap or cover is removed, a bright semi-spot ring of light emanates from the LEDs of the ring. This feature is helpful when the mood light ring is overhead and concentrated colored illumination is needed below the bulb. The long-life solid state LEDs also provides the advantage of lower power consumption than incandescent or halogen light sources.

Accordingly, it is a principal object of the invention to provide a LED lamp ring intermediate the light socket and the light bulb to provide a night light or other decorative light.

It is another object of the invention to provide a number of LEDs on a ring that can be electrically installed between an electrical socket and a light bulb to power the LEDs on the ring.

It is a further object of the invention to provide an LED ring installable on a light socket having a plurality of LEDs that can be white or colored or multicolor to provide decorative or functional lighting.

Still another object of the invention is to provide a DC powered LED light ring that can be installed on a light socket and provides a socket for receipt of a light bulb.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is front elevational view of a LED lamp ring according to the present invention.

FIG. 2 is an exploded perspective view of all components of the LED light bulb.

FIG. 3 is a cross-sectional view of the lamp ring taken along section 3-3 of FIG. 1 with additional environmental details shown.

FIG. 4 is a top plan view of the lamp ring of the present invention.

FIG. 5 is a perspective view of the lamp ring of the present invention.

FIG. 6 is a side elevational view of a second embodiment of the invention.

FIG. 7 is a partial cross-sectional view of the light ring according to a second embodiment of the invention

FIG. 8 is a front elevational view of a light ring according to a third embodiment of the invention.

Similar reference characters denote corresponding features consistently throughout the attached drawings.

### DETAILED DESCRIPTION OF THE PREFERRED EMBODIMENT(S)

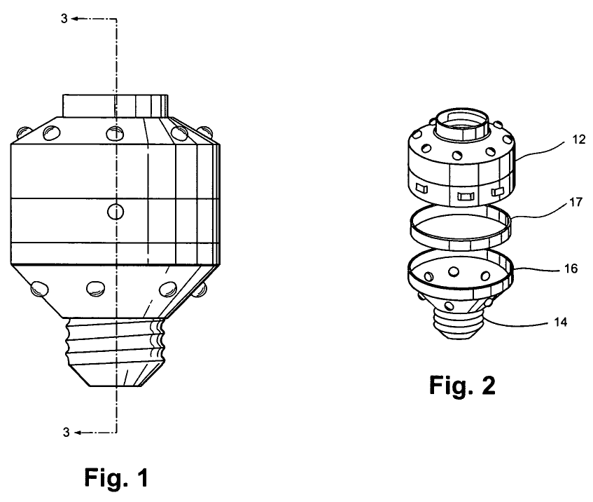

The present invention is best described with reference to the accompanying FIGS. 1-5 to a first embodiment of the invention. FIG. 2 shows an exploded perspective view of all major components of the LED light bulb adapter 10. Bulb socket 14 is connected to heat sink base mount 16. A heat sink unit 12 has a built in AC to DC power supply converter (not shown) or step down converter (not shown) as required to power the LEDs 13 and is machined to fit snugly into heat sink base mount 17. The LEDs 13 are soldered to DC voltage connections on the upper side of heat sink unit 12. A coated, rigid wire 22 having positive and negative leads is preferably provided on the heat sink unit 12 for ready attachment of the LEDs to the heat sink unit 12.

An optically conductive acrylic bulb globe 18 preferably fits into base heat sink unit 12 covering LEDs 6.

An electrical switch 24 on the side of the LED light now controls the on/off condition of the light bulb and the on/off of the ring of colored LEDs 13 located around the base of the light bulb. There is preferably different colors of LEDs and the electrical switch 24 or a separate switch 26 preferably has several positions used to energize the different colors singly or in combination.

Alternatively, there may be electrical circuits (not shown) in the mood light to cause the LEDs 13 to illuminate in sequence or in other pre-programmed sequences.

In one embodiment, the light may contain a photocell 44 to switch electrical power on to the LEDs when ambient light decreases past a threshold amount thereby creating a night light out of a normal table lamp. The color of the night-light is preferably switch selectable. The light may be a mood light containing an electrical circuit sensitive to sound or motion and set to illuminate the ring of LEDs when either occurs within its' sensing area.

The present invention utilizes eight super bright, solid-state light emitting diodes mounted to shine in a vertical direction, however the mounting direction of the LEDs may vary and be at any angle or combination of angles. One skilled in the art would recognize that the number of LEDs can be increased or decreased for ornamental effects or to change the effective brightness or wattage of the light.

The solid state LEDs 13 preferably each have soldered electrical connections at 22 and electrically will last indefinitely, or the LEDs may have miniature socket connections allowing the user to replace the installed LEDs with different colored LEDs. The light transmissive removable cover 18 is colored white, colored a specific color, or combination of colors, or may be frosted to cover the ring of LEDs and may cover some or all of the LEDs. This cover 18 would serve to blend the emitted light of the LEDs creating very colorful special effects, especially when the electrical circuits illuminate different colored LEDs in combination.

The LEDs 13 are generally mounted equally spaced around in a circle on the metal surface of the heat shield, however the LEDs may be mounted in any location on the mood light and in any direction including down. LEDs mounted to direct light downwardly would illuminate the area proximate the base of the lamp further enhancing both the mood and night light characteristics of the instant invention. An electrical circuit that rectifies 115-VAC house current and reduces the DC output voltage to that required by the electrical series, series parallel, or parallel connection of the multiple LEDs is located in the base of the mood light ring beneath the metal surface upon which the LEDs are mounted.

A lamp socket 32 on a lamp 30 or similar device receives the bulb socket 14 by threaded engagement to electrically connect the solid state LED ring lamp to the electric line coming into the lamp from a wall socket (not shown) or similar device in a well known manner. The lamp socket 32 is preferably a “household lamp socket” which is hereby defined as a conventional lamp socket configured to accept a standard 60 Watt, 120 Volt light bulb available from Phillips or General Electric.

A removable, optically conductive lens cap or cover is press fitted, or threadedly attached to cover the LEDS of the mood light ring. The acrylic or other plastic cover over the LEDs not only blends and combines the illumination from the different colored LEDs but also disperses and diffuses the light from the LEDs out of the bulb globe in any and all directions When electrical power is applied to the LEDs of the mood light ring, and the lens cap or cover is removed, a bright semi-spot ring of light emanates from the LEDs of the ring. The cover 18 may be in sections or hinged to facilitate removal. This feature is helpful when the mood light ring is overhead and concentrated colored illumination is needed below the bulb. The long-life solid state LEDs also provides the advantage of lower power consumption than incandescent or halogen light sources.

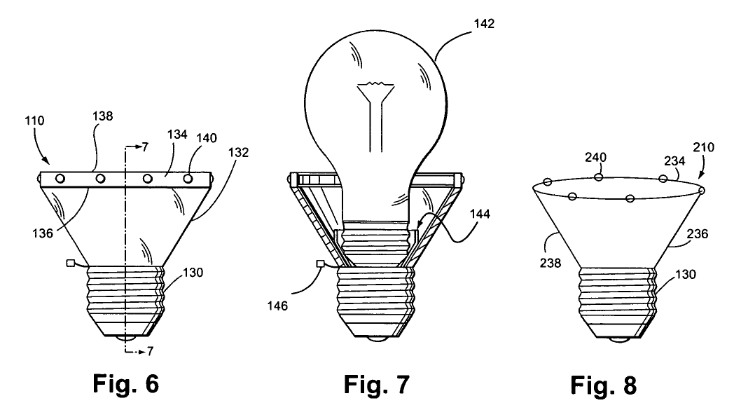

In a second embodiment as best described with reference to FIGS. 6 and 7 shows a variation of the lamp ring. A simplified lamp ring 110 according to a second embodiment of the invention has a skirt 132 of plastic, glass, or similar transparent or translucent material mounted atop of a bulb socket 130 for threadedly engaging a lamp socket. The skirt 132 can also be omitted as in the third embodiment shown in FIG. 8 and describe further below.

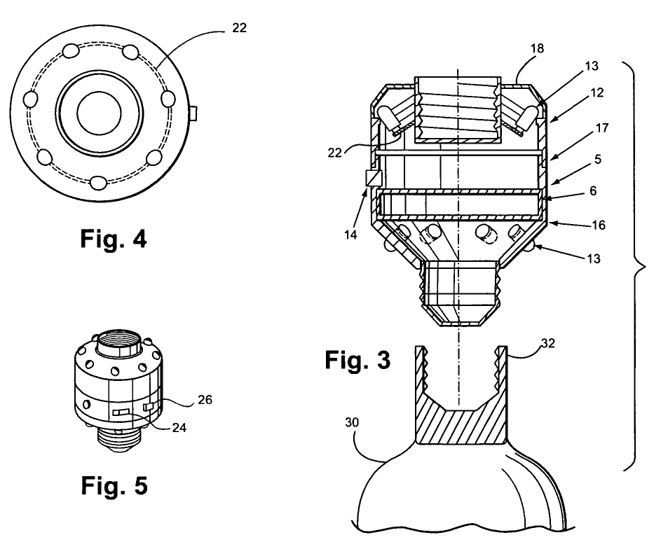

The skirt 132 has a top ring 134 which may be solid or may just contain a positive lead 136 and a negative lead 138 cover by or coated with an insulating material. LEDs 140 mounted around the top of the skirt 132 are electrically connected to the leads to provide power. As described above, a step down transformer and converter (not shown) may be provided as need to converter the AC current to the proper DC voltage required by the LEDs. As shown in the partial cross-section of FIG. 7, a standard light bulb 142 is received by the lamp ring 110 by a socket 144 for threaded engagement. The light bulb receives electrical power from the bulb socket 130 which is threadedly engaged in a lamp socket (32, FIG. 3).

A switch 146 or number of switches are provided to control the illumination and color of the LEDs 140 mounted on the lamp ring. The skirt 132 can be clear or frosted to transmit or diffuse the light from the LEDs as needed. In FIG. 8, the skirt has been omitted entirely from the lamp ring 210. Instead electrical leads 236,238 provide electrical power to a ring 234 at an upper edge of the lamp ring. The ring comprises coated or insulated electrical wires connected to the positive and negative leads 236,238 for connecting a plurality of LEDs 240. The wires should be rigid enough to support the LEDS and may include internal support arms (not shown) that brace the LEDs at a predetermined distance outward from a light bulb 142. An internal light bulb receiving socket may or may not be provided for receiving a light bulb interior to the lamp ring as described above in the second embodiment. The lamp ring can be used in place of a light bulb or in conjunction with the light bulb.

It is to be understood that the present invention is not limited to the sole embodiment described above, but encompasses any and all embodiments within the scope of the following claims.

1. A lamp adapter for installation between a lamp socket and a light bulb comprising:
a bulb socket for threaded attachment within the lamp socket;
a light bulb receiving socket electrically connected to said bulb socket for receiving a light bulb;
an LED ring electrically connected to said bulb socket for receiving at least one LED;
an LED in electric communication with said LED ring.
